(19) United States
(12) Patent Application Publication
(10) Pub. No.: US 2025/0316900 A1
(43) Pub. Date: Oct. 9, 2025

(54) ANTENNA ASSEMBLY

(71) Applicant: KYOCERA AVX Components (San Diego), Inc., San Diego, CA (US)

(72) Inventors: Weichun Eric Lin, San Diego, CA (US); Fenfen Qiu, San Diego, CA (US)

(21) Appl. No.: 19/170,890

(22) Filed: Apr. 4, 2025

Related U.S. Application Data
(60) Provisional application No. 63/575,204, filed on Apr. 5, 2024.

(51) Int. Cl. H01Q 5/307; H01Q 1/22; H01Q 1/42; H01Q 1/52; H01Q 5/20

(52) U.S. Cl. CPC H01Q 5/307; H01Q 1/22; H01Q 1/42; H01Q 1/526; H01Q 5/20

(57) ABSTRACT

An antenna assembly is provided. The antenna assembly includes an antenna housing having a sidewall, an exterior surface of the sidewall at least partially enclosed by a metal frame. The antenna assembly further includes an antenna positioned along an interior surface of the sidewall. The antenna includes one or more antenna elements operable to communicate over one or more frequency bands. The antenna further includes a coupling element connected to at least one antenna element of the one or more antenna elements. The coupling element is capacitively coupled to the metal frame through the sidewall of the antenna housing.

### PRIORITY CLAIM

The present application is based on and claims priority to U.S. Provisional Application 63/575,204 having a filing date of Apr. 5, 2024, which is incorporated by reference herein.

### FIELD

The present disclosure relates generally to an antenna assembly, and more specifically to an antenna assembly for use within an electronic device.

### BACKGROUND

Antennas can be used to facilitate wireless communication between devices. It can be desirable for antennas to operate with a high efficiency to improve wireless communication between devices. Antennas may be incorporated into a variety of different types of electronic devices to provide for wireless communication. An antenna assembly may include one or more antennas to facilitate wireless communication over a variety of different frequency bands/protocols.

### SUMMARY

Aspects and advantages of embodiments of the present disclosure will be set forth in part in the following description, or can be learned from the description, or can be learned through practice of the embodiments.

One example aspect of the present disclosure is directed to an antenna assembly. The antenna assembly includes an antenna housing having a sidewall, an exterior surface of the sidewall at least partially enclosed by a metal frame. The antenna assembly further includes an antenna positioned along an interior surface of the sidewall. The antenna includes one or more antenna elements operable to communicate over one or more frequency bands. The antenna further includes a coupling element connected to at least one antenna element of the one or more antenna elements. The coupling element is capacitively coupled to the metal frame through the sidewall of the antenna housing.

Another example embodiment of the present disclosure is directed to an antenna positioned at least partially within an antenna housing. The antenna includes a carrier. The antenna further includes a first antenna element positioned on a first surface of the carrier. The antenna further includes a coupling element positioned on the first surface of the carrier, the coupling element connected to the first antenna element. The coupling element is capacitively coupled to a metal frame positioned outside the antenna housing, the metal frame electrically isolated from the antenna.

Another example embodiment of the present disclosure is directed to an electronic device. The electronic device includes a metal frame. The electronic device further includes an antenna housing having a sidewall, an exterior surface of the sidewall at least partially enclosed by the metal frame. The electronic device further includes an antenna positioned along an interior surface of the antenna housing. The antenna includes a first antenna element operable to communicate over one or more frequency bands. The antenna further includes a coupling element connected to the first antenna element. The coupling element is capacitively coupled to the metal frame through the sidewall of the antenna housing.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 provides perspective views of an example antenna according to example embodiments of the present disclosure;

FIG. 2 provides another perspective view of an example antenna according to example embodiments of the present disclosure;

FIG. 3 illustrates a plan view of an example antenna package according to example embodiments of the present disclosure;

FIG. 4A provides a perspective view of an example antenna assembly according to example embodiments of the present disclosure;

FIG. 4B provides a perspective view of an example electronic device according to example embodiments of the present disclosure;

FIG. 5 illustrates an exploded side view of an example coupling element, antenna housing, and metal frame according to example embodiments of the present disclosure;

FIG. 6 provides a block diagram depicting an example electronic device according to example embodiments of the present disclosure;

FIGS. 7A and 7B provide efficiency plots of an example first antenna element according to example embodiments of the present disclosure;

FIG. 8 provides an efficiency plot of an example second antenna element according to example embodiments of the present disclosure;

FIG. 9 provides an example antenna isolation plot of example antenna elements according to example embodiments of the present disclosure.

Repeat use of reference characters in the present specification and drawings is intended to represent same or analogous features or elements of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value refers to a value that falls within 10% of the stated numerical value.

Example aspects of the present disclosure are directed to an antenna assembly for use in, for instance, a wide variety of applications. For example, the antenna assembly may be implemented in an electronic device, such as an electronic locking device, to facilitate wireless communication with other devices (e.g., remote devices). In general, an electronic device may include an antenna housing, such as a plastic antenna housing, configured to house the antenna within the electronic device. The implementation of an antenna within an electronic device may prove challenging as conductive structures of the electronic device positioned outside the antenna housing may affect performance characteristics of the antenna if not coupled to the antenna. For instance, a metal frame partially enclosing the antenna housing may degrade signals communicated by the antenna. As such, coupling the antenna to the metal frame may improve performance characteristics (e.g., antenna radiation efficiency, etc.) of the antenna.

Antennas positioned within (e.g., at least partially within) an antenna housing may provide additional design challenges, as the conductive structures that may affect antenna performance characteristics may be separated from the antenna by the antenna housing. For example, a metal frame at least partially enclosing the antenna housing may be separated from the antenna by, for instance, a sidewall of the antenna housing.

As such, example aspects of the present disclosure provide an antenna having a coupling element capacitively coupled to the metal frame through the antenna housing. For instance, the coupling element may be positioned along an interior surface of a sidewall of the antenna housing while the metal frame may be positioned on an exterior surface of the sidewall. The positioning of the coupling element relative to the metal frame may provide a coupling capacitance such that energy may be transferred via an electric field.

The coupling element may be connected to one or more antenna elements of the antenna. For example, the coupling element may act as a grounding element for an antenna element such that energy provided to the grounding element may be transferred (e.g., via the coupling element) to the metal frame.

As used herein, two conductors may be referred to as being “capacitively coupled” when energy may be transferred between the electrically isolated conductors without a direct electrical connection. Two conductors may be referred to as being “electrically isolated” when no direct electrical connection exists between the conductors, such that the flow of direct current (DC) is blocked between the conductors.

In some embodiments, the antenna may be configured to facilitate communication over a variety of different frequency bands/protocols. For instance, the antenna may include one or more antenna elements operable over frequency bands associated with cellular (e.g., long term evolution (LTE)), global positioning system (GPS), Bluetooth (BT), and/or near field communication (NFC) systems and/or protocols. Additional challenges may be provided for an antenna having multiple antenna elements as antenna isolation between the antenna elements may be negatively impacted. For instance, the configuration (e.g., positioning) of the antenna elements and other components of the antenna in close proximity may, for example, cause interference between the antenna. This may negatively impact performance characteristics, such as antenna radiation efficiency, of the antenna elements. Accordingly, aspects of the present disclosure provide an antenna assembly that may provide for improved antenna performance characteristics, such as antenna radiation efficiency.

Aspects of the present disclosure provide a number of technical effects and benefits. For instance, example embodiments of the present disclosure may provide for improved antenna performance characteristics, such as antenna isolation and/or antenna radiation efficiency. In addition, example embodiments of the present disclosure may provide an antenna configured to facilitate wireless communicate over multiple different frequency bands/protocols such as frequency bands associated with cellular (e.g., long term evolution (LTE)), global positioning system (GPS), Bluetooth (BT), and/or near field communication (NFC) systems and/or protocols.

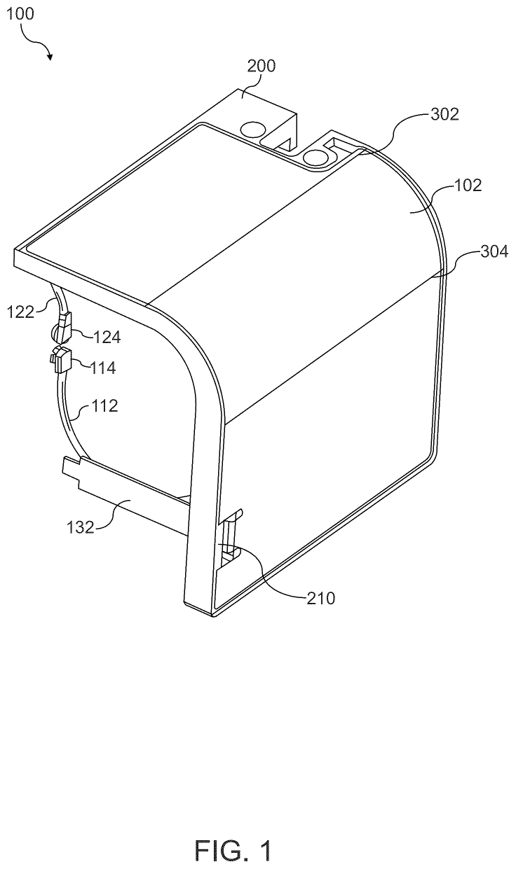

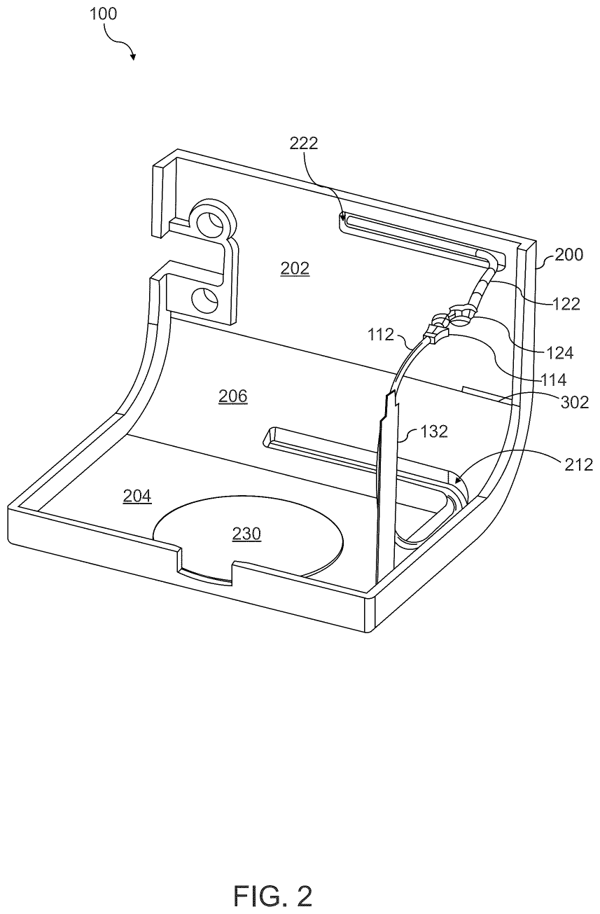

Referring now to the FIGS., FIGS. 1-2 provide perspective views of an example antenna 100 according to example embodiments of the present disclosure is provided.

Antenna 100 may include an antenna package 102 positioned on a carrier 200. Antenna package 102 may include one or more antenna elements operable to communicate over one or more frequency bands. Antenna package 102 may further include a coupling element connected to one or more of the antenna elements of the antenna package 102. In some embodiments, antenna package 102 may be a flexible antenna package positioned on, for instance, a surface of a carrier 200.

Accordingly, antenna 100 may further include a carrier 200. As shown in FIG. 1, antenna package 102 may be positioned on a first surface 210 (e.g., convex surface) of carrier 200. In some embodiments, carrier 200 may be an L shaped carrier. For instance, carrier 200 may be bent (e.g., folded) along lines 302, 304 such that carrier 200 may include a first leg portion 202 and a second leg portion 204, each leg portion 202, 204 extending from a curved portion 206 of carrier 200. In some embodiments, first leg portion 202 may extend from curved portion 206 in a first direction and second leg portion 204 may extend from curved portion 206 in a second direction, the first direction being generally perpendicular to the second direction.

In some embodiments, at least a portion of carrier 200 may include an electromagnetic interference (EMI) suppressing material. For instance, as shown in FIG. 2, portion 230 of carrier 200 may include an EMI suppressing material, such as ferrite. In some embodiments, an antenna element of antenna package 102 may be positioned on the portion 230 of carrier 200 including the EMI suppressing material.

In some embodiments, antenna 100 may further include a first electrical connector 114 and a second electrical connector 124. As shown, first electrical connector 114 may be coupled to antenna package 102 via transmission line 112 while second electrical connector 124 may be coupled to antenna package 102 via transmission line 122. In some embodiments, a first antenna element of antenna package 102 may be connected to the first electrical connector 114 via transmission line 112 while a second antenna element of antenna package 102 may be connected to the second electrical connector 124 via transmission line 122.

In some embodiments, transmission line 112 and transmission line 122 may extend through apertures 212, 222 in carrier 200. For instance, transmission line 112 may extend from antenna package 102 to electrical connector 114 through first aperture 212 in carrier 200 while transmission line 122 may extend from antenna package 102 to electrical connector 124 through second aperture 222 of carrier 200.

In some embodiments, antenna 100 may further include a connector component 132 configured to connect to a third antenna element of antenna package 102.

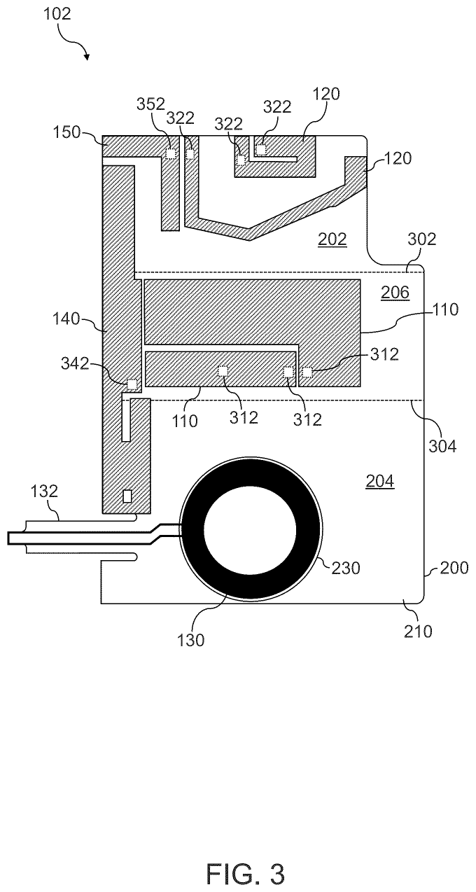

FIG. 3 illustrates a plan view of an example configuration of antenna package 102 according to example embodiments of the present disclosure. As previously described with reference to FIGS. 1-2, antenna package 102 includes one or more antenna elements and a coupling element positioned on a first surface 210 of carrier 200. As shown in FIG. 3, antenna package 102 may include antenna elements 110, 120, 130 and coupling elements 140, 150 positioned along a first surface 210 of carrier 200. While carrier 200 is generally depicted in FIGS. 1A-2 as being an L shaped carrier, those of ordinary skill in the art will understand that antenna package 102 may be positioned on a carrier 200 having any suitable shape without deviating from the scope of the present disclosure.

As shown in FIG. 3, antenna package 102 may include a first antenna element 110 and a coupling element 140 positioned on a first surface 210 of carrier 200. Coupling element 140 may be connected to first antenna element 110. For instance, transmission line 112 (FIGS. 1-2) may connect to the first antenna element 110 via connection points 312. Transmission line 112 (FIGS. 1-2) may be further coupled to the coupling element 140 at connection point 342, such that first antenna element 110 is coupled to coupling element 140 via transmission line 112 (FIGS. 1-2).

In some embodiments, coupling element 140 may act as a grounding element for the first antenna element 110. For instance, first antenna element 110 may act as a radiator element while coupling element 140 may provide a grounding element to the first antenna element (e.g., radiator element). While first antenna element 110 is depicted in FIG. 3 with two antenna components (e.g., antenna patterns), those of ordinary skill in the art will understand that first antenna element 110 may include any suitable number of antenna components. In addition, first antenna element 110 (e.g., antenna components of first antenna element 110) may have any suitable shape without deviating from the scope of the present disclosure.

In some embodiments, first antenna element 110 may be operable over one or more long term evolution (LTE) frequency bands. In further embodiments, first antenna element 110 may be operable over one or more long term evolution (LTE) frequency bands as well as one or more global positioning system (GPS) frequency bands. For instance, first antenna element 110 may be a long term evolution (LTE) and global positioning system (GPS) antenna element.

Antenna package 102 may further include a second antenna element 120. For instance, as shown in FIG. 3, second antenna element 120 may be positioned on the first surface 210 of carrier 200. Second antenna element 120 may be operable to communicate via an 802.15 communication protocol. For instance, second antenna element 120 may be a Bluetooth (BT) antenna element. While second antenna element 120 is depicted in FIG. 3 with two antenna components (e.g., antenna patterns), those of ordinary skill in the art will understand that second antenna element 120 may include any suitable number of antenna components. In addition, second antenna element 120 (e.g., antenna components of second antenna element 120) may have any suitable shape without deviating from the scope of the present disclosure.

In some embodiments, antenna package 102 may further include a second coupling element 150 connected to the second antenna element 120. For instance, transmission line 122 (FIGS. 1-2) may connect to the second antenna element 120 via connection points 322. Transmission line 122 (FIGS. 1-2) may be further coupled to the second coupling element 150 at connection point 352, such that second antenna element 120 is coupled to the second coupling element 150 via transmission line 122 (FIGS. 1-2). In some embodiments, the second coupling element 150 may act as a grounding element for the second antenna element 120.

Antenna package 102 may further include a third antenna element 130 positioned on first surface 210 of carrier 200. Third antenna element 130 may be operable to communicate over one or more near field communication (NFC) frequency bands. For instance, third antenna element 130 may be an NFC antenna coil. As previously described, a connector component 132 may be connected to the third antenna element 130.

In some embodiments, third antenna element 130 may be positioned on portion 230 of carrier 200 having an EMI suppressing material. For instance, as shown in FIG. 3, the third antenna element 130 may be positioned on portion 230 having an EMI suppressing material such as ferrite.

In some embodiments, carrier 200 may be an L shaped carrier. For instance, as previously described with reference to FIGS. 1-2, carrier 200 may be bent (e.g., folded) along lines 302, 304 such that carrier 200 may include a first leg portion 202 and a second leg portion 204, each leg portion 202, 204 extending from a curved portion 206 of carrier 200. Accordingly, coupling element 140 may be positioned on carrier 200 such that the coupling element 140 extends along the first leg portion 202, curved portion 206, and second leg portion 204 of carrier 200. In addition, a majority portion of the first antenna element 110 may be positioned on the curved portion 206 of carrier 200 (e.g., between lines 302 and 304). In further embodiments, the second antenna element 120 may be positioned on the first leg portion 202 while the third antenna element 130 may be positioned on the second leg portion 204 of carrier 200.

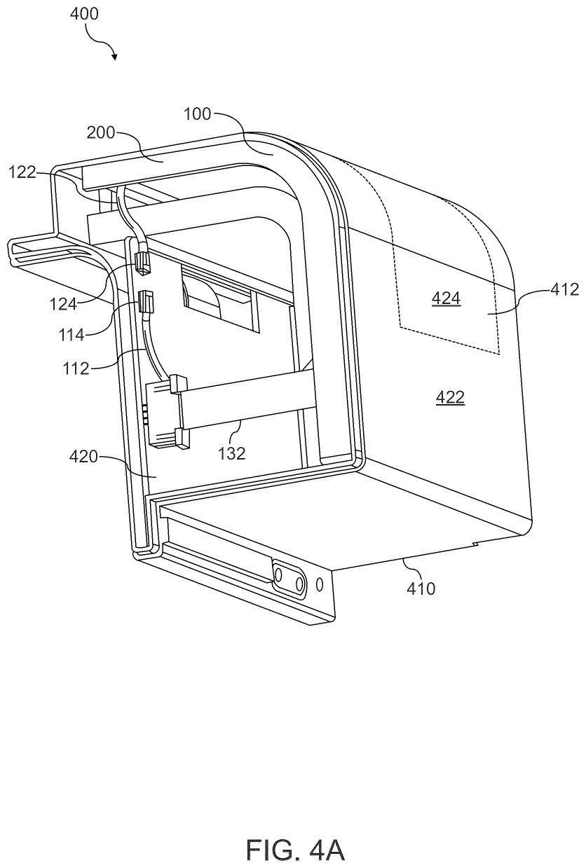

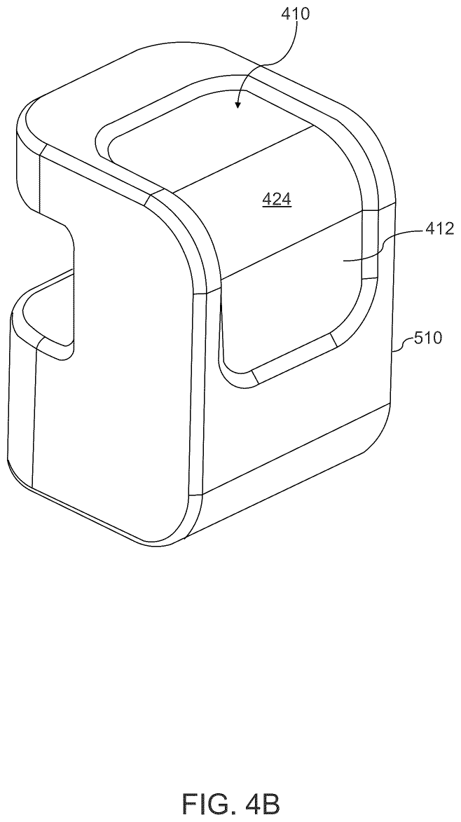

Referring now to FIG. 4A, a perspective view of an antenna assembly 400 is provided according to example embodiments of the present disclosure. Antenna assembly 400 includes an antenna, such as antenna 100 depicted in FIGS. 1-3, housed at least partially within an antenna housing 410. Antenna housing 410 may be, for instance, a plastic antenna housing.

As shown in FIG. 4A, antenna housing 410 may include a sidewall 412. While sidewall 412 is generally depicted as a curved (e.g., L shaped) sidewall, those of ordinary skill in the art will understand that sidewall 412 may have any suitable shape without deviating from the scope of the present disclosure. Antenna 100 may be positioned along an interior surface of sidewall 412. For instance, antenna 100 may be inserted (e.g., slid) into antenna housing 410 such that antenna package (FIG. 1) is positioned on an interior surface of sidewall 412.

In some embodiments, antenna assembly 400 may further include a circuit board assembly 420 at least partially enclosed within antenna housing 410. As shown, the first electrical connector 114, second electrical connector 124, and connector component 132 of antenna 100 may be connected to circuit board assembly 420.

Antenna housing 410 (e.g., sidewall 412 of antenna housing 410) may be at least partially enclosed by a metal frame. As such, sidewall 412 may have a first portion 422 that is enclosed by the metal frame. For instance, a metal frame may extend over a first portion 422 (e.g., exterior surface of first portion 422) of sidewall 412 while a second portion 424 of sidewall 412 may not be enclosed by a metal frame.

In some embodiments, first portion 422 of sidewall 412 may overlap a coupling element of antenna 100, such as coupling element 140 and/or second coupling element 150 depicted in FIG. 3. For instance, antenna 100 may be positioned along an interior surface of sidewall 412 such that coupling element(s) (FIG. 3) extend along the interior surface of the first portion 422 of the sidewall 412.

FIG. 4B illustrates a perspective view of an electronic device 500. As shown, electronic device 500 may include an antenna assembly, such as antenna assembly 400 of FIG. 4A, partially enclosed by a metal frame 510. Specifically, sidewall 412 of antenna housing 410 may be partially enclosed by metal frame 510. As previously described, metal frame 510 may extend over a first portion 422 (FIG. 4A) of sidewall 412 while a second portion 424 of sidewall 412 may not be enclosed by metal frame 510. In some embodiments, electronic device 500 may be an electronic locking device.

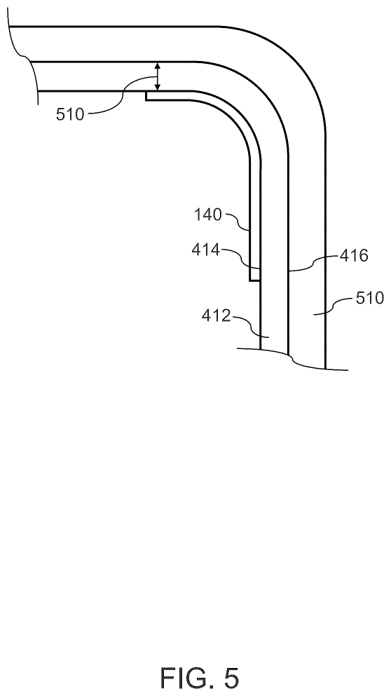

Referring now to FIG. 5, a cross-sectional side view of a coupling element 140 and metal frame 510 positioned along sidewall 412 of an antenna housing, such as antenna housing 410 of FIGS. 4A-4B is depicted. As previously described, coupling element 140 may be capacitively coupled to the metal frame 510 through sidewall 412. Accordingly, coupling element 140 may be separated from metal frame 510 by sidewall 412, such as a plastic sidewall, of an antenna housing. For instance, coupling element 140 may be electrically isolated from metal frame 510 by sidewall 412. As shown, coupling element 140 may be positioned along an interior surface 414 of sidewall 412 while metal frame 510 may be positioned along an exterior surface 416 of sidewall 412.

In some embodiments, a distance 550 between coupling element 140 and metal frame 510 may be set such that the coupling element may be capacitively coupled to the metal frame. For instance, distance 550 may correspond to a width of sidewall 412. In some embodiments, distance 550 between the coupling element 140 and metal frame 510 may be less than about 3 millimeters (mm), such as less than about 2 millimeters (mm), such as about 1.8 millimeters (mm).

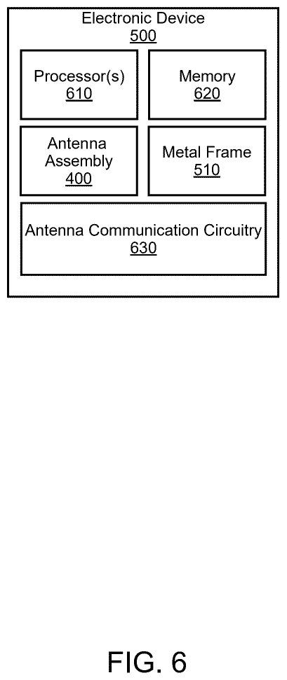

FIG. 6 provides a block diagram depicting an example electronic device, such as electronic device 500 illustrated in FIG. 4B. Electronic device 500 may be any suitable electronic device configured to have wireless communication with one or more remote devices. For instance, electronic device 500 can be a computing device (e.g., laptop, desktop, display with one or more processors), mobile device (e.g., phone, tablet, wearable device (e.g., watch)), vehicle, nautical vehicle, aircraft, satellite, keyless entry device, or other electronic device. In some embodiments, electronic device 500 may be an electronic locking device. While electronic device 500 is described in FIG. 6 with reference to antenna assembly 400 as described in FIG. 4A, those of ordinary skill in the art, using the disclosures provided herein, will understand that any aspect of antenna assembly 400 or antenna 100 described herein can be implemented in electronic device 500 for use in a variety of applications without deviating from the scope of the present disclosure.

As shown in FIG. 6, electronic device 500 includes an antenna assembly 400 having an antenna, such as antenna 100 depicted in FIGS. 1-2. As previously described, antenna assembly 400 may include an antenna housing 410 (FIG. 4) at least partially enclosing antenna 100.

Electronic device 500 further includes a metal frame 510 positioned along at least a portion of an external surface of the antenna housing of the antenna assembly 400. For instance, as illustrated in FIG. 5, a coupling element of antenna assembly 400 may be capacitively coupled to the metal frame 510 through the antenna housing (e.g., sidewall of antenna housing) of the antenna assembly 400.

Electronic device 500 may further include communication circuitry 630 (e.g., radio frequency (RF) circuitry, transmission line, transceiver, receiver, transmitter, matching circuit etc.) configured to facilitate communication of information to and/or from antenna assembly 400. In some embodiments, a processor(s) 610 may be in electrical communication with antenna assembly 400 via communication circuitry 630. In this manner, RF signals received at antenna assembly 400 may be provided to processor(s) 610 via communication circuitry 630. In addition, the one or more processor(s) 610 may be configured to provide data to the antenna assembly 400 via communication circuitry 630.

In some embodiments, electronic device 500 may further include memory 620 and one or more processor(s) 610. Processor(s) 610 can include any suitable processing device and may be configured to perform a variety of computer implemented functions. As used herein, the term “processor” refers not only to integrated circuits referred to in the art as being included in a computer, but may also refer to a microprocessor, CPU, GPU, controller, microcontroller, a microcomputer, a programmable logic controller (PLC), an application specific integrated circuit (ASIC), a Field Programmable Gate Array (FPGA), and/or other programmable circuits. As shown, electronic device 500 may further include memory 620. Examples of memory 620 can include computer-readable media including, but not limited to, non-transitory computer-readable media, such as RAM, ROM, hard drives, flash drives, or other suitable memory devices. Memory 620 can store information accessible by the one or more processor(s) 610, including computer-readable instructions that can be executed by the one or more processor(s) 610. For example, the computer-readable instructions can be software written in any suitable programming language or may be implemented in hardware. In some embodiments, the one or more processor(s) 610 along with memory 620 may be defined as one or more control devices configured to control operation of antenna assembly 400.

In some embodiments, electronic device 500 may further include one or more screen(s) (e.g., display screen, touch screen) and/or one or more input device(s) (e.g., key pad, touch pad, keyboard).

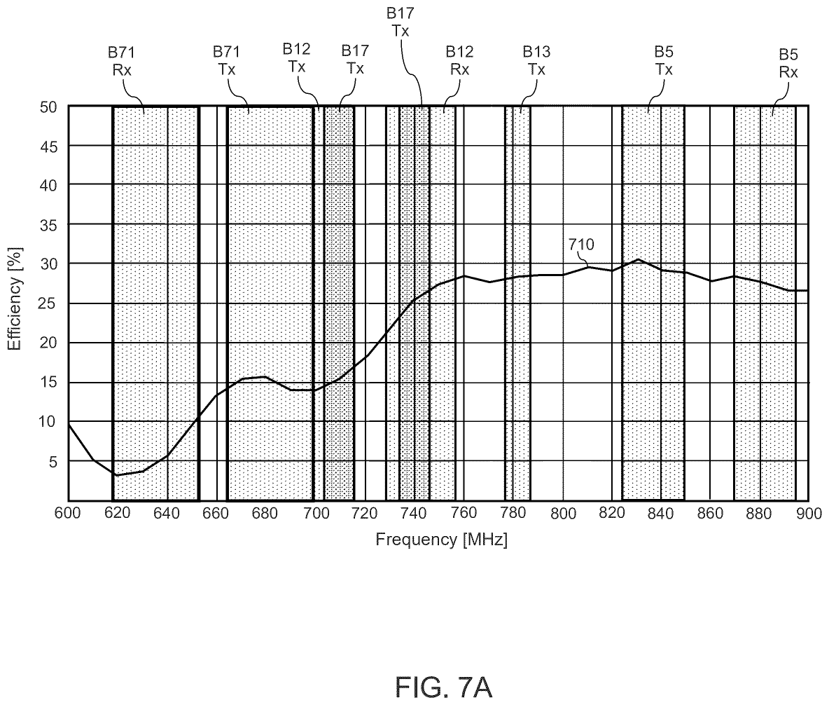

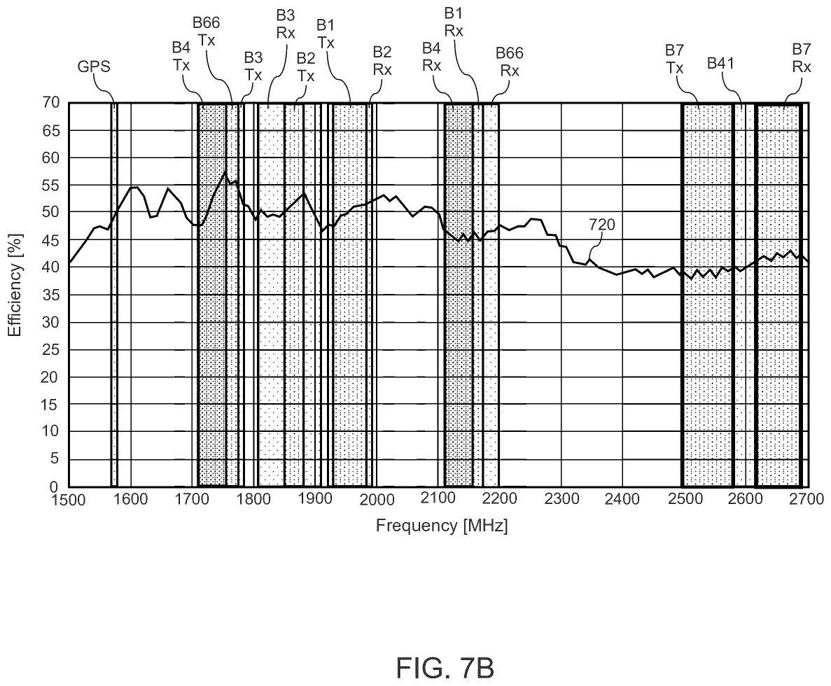

FIGS. 7A and 7B provide plots of example efficiency (e.g., antenna radiation efficiency) of a first antenna element 110 of the antenna 100 within an electronic device, such as electronic device 500 depicted in FIGS. 5-6. As shown, the plots in FIGS. 7A & 7B illustrate the efficiency (e.g., as a percentage [%]) of the first antenna element 110 as a function of frequency (denoted along the horizontal axis in Megahertz [MHz]). As previously discussed, first antenna element 110 of antenna 100 may be operable over one or more long term evolution (LTE) frequency bands and one or more global positioning system (GPS) frequency bands (e.g., LTE/GPS antenna element). Accordingly, first antenna element 110 may be configured to operate in a plurality of bands over a first frequency range of about 600 MHz to about 900 MHZ as depicted in the plot shown in FIG. 7A as well as a plurality of bands over a second frequency range of about 1500 MHz to about 2700 MHz as depicted in the plot shown in FIG. 7B.

Referring now specifically to FIG. 7A, an example efficiency of first antenna element 110 of the antenna 100 is depicted over various LTE frequency bands. As may be seen, curve 710 illustrates the antenna radiation efficiency of first antenna element 110 over a range of frequencies spanning from about 600 Megahertz (MHz) to about 900 MHz. As shown, the first antenna element 110 may be operable over a plurality of LTE frequency bands, such as LTE frequency bands 71, 12, 17, 13, and/or 5.

Referring now specifically to FIG. 7B, an example efficiency of first antenna element 110 of the antenna 100 is depicted over various LTE frequency bands, such as LTE frequency band 1, 2, 3, 4, 7, 41 and/or 66, as well as the L1 frequency band (e.g., GPS L1 frequency band). Accordingly, antenna element 110 may be a LTE/GPS antenna element. As may be seen, curve 720 illustrates the antenna radiation efficiency of first antenna element 110 over a range of frequencies spanning from about 1,500 MHz to about 2,700 MHZ.

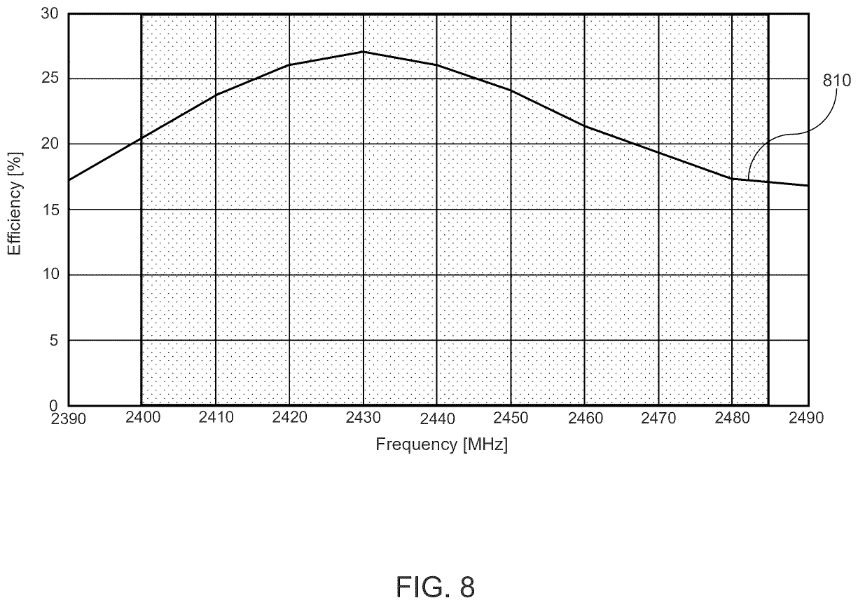

FIG. 8 provides a plot of example efficiencies (e.g., antenna radiation efficiencies) of a second antenna element 120 of antenna 100 within an electronic device, such as electronic device 500 depicted in FIGS. 5-6. As shown, the plot in FIG. 8 illustrates the efficiency (e.g., as a percentage [%]) of the second antenna element 120 as a function of frequency (denoted along the horizontal axis in Megahertz). As previously discussed, second antenna element 120 of antenna 100 may be operable to communicate via an 802.15 communication protocol. For instance, second antenna element 120 may be a Bluetooth (BT) antenna element. As may be seen, curve 810 illustrates the antenna radiation efficiency of second antenna element 120 over a range of frequencies spanning from about 2,390 MHz (e.g., about 2.39 GHZ) to about 2,490 MHz (e.g., about 2.49 GHZ).

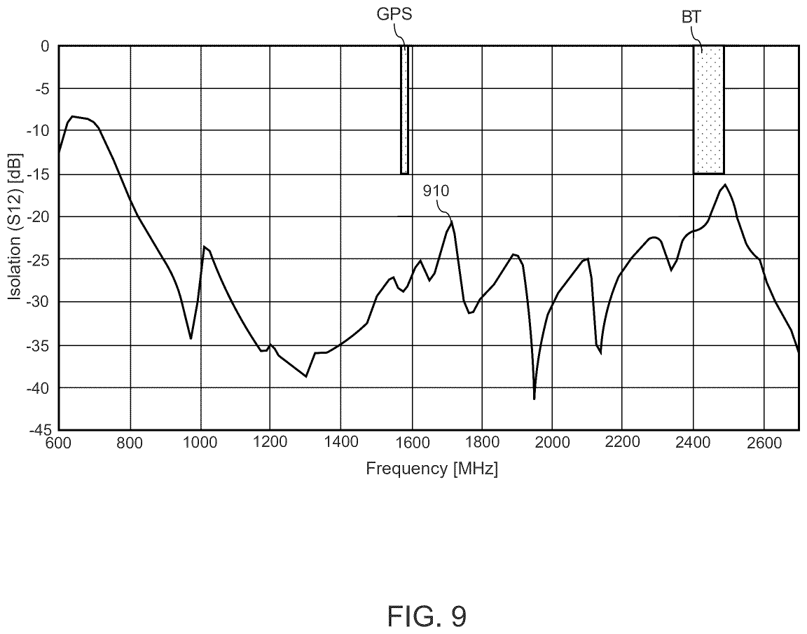

FIG. 9 provides an example antenna isolation plot of antenna elements of antenna 100 within an electronic device, such as electronic device 500 depicted in FIGS. 5-6. The plot shown in FIG. 9 provides antenna isolation (e.g., S12) as a decibel (dB) value along the vertical axis and the operating frequency in Megahertz (MHz) along the horizontal axis. Specifically, the plot of FIG. 9 shows antenna isolation (e.g., S12) of the first antenna element 110 and second antenna element 120. Accordingly, curve 910 is associated with the antenna isolation between first antenna element 110 and second antenna element 120 of antenna 100.

One example aspect of the present disclosure is directed to an antenna assembly. The antenna assembly includes an antenna housing having a sidewall, an exterior surface of the sidewall at least partially enclosed by a metal frame. The antenna assembly further includes an antenna positioned along an interior surface of the sidewall. The antenna includes one or more antenna elements operable to communicate over one or more frequency bands. The antenna further includes a coupling element connected to at least one antenna element of the one or more antenna elements. The coupling element is capacitively coupled to the metal frame through the sidewall of the antenna housing.

In some examples, the metal frame extends over a first portion of the sidewall, the first portion overlapping the coupling element along the sidewall.

In some examples, a distance between the coupling element and the metal frame through the sidewall is less than about 2 millimeters (mm).

In some examples, the one or more antenna elements include a first antenna element operable over one or more long term evolution (LTE) frequency bands.

In some examples, the first antenna element is operable over one or more long term evolution (LTE) frequency bands and one or more global positioning system (GPS) frequency bands.

In some examples, the one or more antenna elements further include a second antenna element operable to communicate via an 802.15 communication protocol.

In some examples, the one or more antenna elements further include a third antenna element operable to communicate over one or more near field communication (NFC) frequency bands.

In some examples, the antenna further includes a carrier, the one or more antenna elements positioned along a surface of the carrier. In some examples, the third antenna element is positioned on a portion of the carrier comprising an electromagnetic interference (EMI) suppressing material.

In some examples, the EMI suppressing material comprises ferrite.

Another example embodiment of the present disclosure is directed to an antenna positioned at least partially within an antenna housing. The antenna includes a carrier. The antenna further includes a first antenna element positioned on a first surface of the carrier. The antenna further includes a coupling element positioned on the first surface of the carrier, the coupling element connected to the first antenna element. The coupling element is capacitively coupled to a metal frame positioned outside the antenna housing, the metal frame electrically isolated from the antenna.

In some examples, the carrier includes a curved portion, a first leg portion extending from the curved portion in a first direction, and a second leg portion extending from the curved portion in a second direction generally perpendicular to the first direction. In some examples, a majority portion of the first antenna element is positioned on the curved portion of the carrier.

In some examples, the coupling element extends along the first leg portion, the curved portion, and the second leg portion of the carrier.

In some examples, the antenna further includes a second antenna element positioned on the first leg portion of the carrier and a third antenna element positioned on the second leg portion of the carrier.

In some examples, the second antenna element is operable to communicate via an 802.15 communication protocol and the third antenna element is operable to communicate over one or more near field communication (NFC) frequency bands.

In some examples, the first antenna element is operable over one or more long term evolution (LTE) frequency bands and one or more global positioning system (GPS) frequency bands.

In some examples, a distance between the coupling element and the metal frame is less than about 2 millimeters (mm).

Another example embodiment of the present disclosure is directed to an electronic device. The electronic device includes a metal frame. The electronic device further includes an antenna housing having a sidewall, an exterior surface of the sidewall at least partially enclosed by the metal frame. The electronic device further includes an antenna positioned along an interior surface of the antenna housing. The antenna includes a first antenna element operable to communicate over one or more frequency bands. The antenna further includes a coupling element connected to the first antenna element. The coupling element is capacitively coupled to the metal frame through the sidewall of the antenna housing.

In some examples, the first antenna element is operable over one or more long term evolution (LTE) frequency bands.

In some examples, a distance between the coupling element and the metal frame through the sidewall is less than about 2 millimeters (mm).

In some examples, the electronic device is an electronic locking device.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An antenna assembly, comprising:
an antenna housing having a sidewall, an exterior surface of the sidewall at least partially enclosed by a metal frame;
an antenna positioned along an interior surface of the sidewall, the antenna comprising:
one or more antenna elements operable to communicate over one or more frequency bands; and
a coupling element connected to at least one antenna element of the one or more antenna elements,
wherein the coupling element is capacitively coupled to the metal frame through the sidewall of the antenna housing.

2. The antenna assembly of claim 1, wherein the metal frame extends over a first portion of the sidewall, the first portion overlapping the coupling element along the sidewall.

3. The antenna assembly of claim 1, wherein a distance between the coupling element and the metal frame through the sidewall is less than about 2 millimeters (mm).

4. The antenna assembly of claim 1, wherein the one or more antenna elements comprises:
a first antenna element operable over one or more long term evolution (LTE) frequency bands.

5. The antenna assembly of claim 4, wherein the first antenna element is operable over one or more long term evolution (LTE) frequency bands and one or more global positioning system (GPS) frequency bands.

6. The antenna assembly of claim 4, wherein the one or more antenna elements further comprises:
a second antenna element operable to communicate via an 802.15 communication protocol.

7. The antenna assembly of claim 6, wherein the one or more antenna elements further comprises:
a third antenna element operable to communicate over one or more near field communication (NFC) frequency bands.

8. The antenna assembly of claim 7, wherein the antenna further comprises a carrier, the one or more antenna elements positioned along a surface of the carrier,
wherein the third antenna element is positioned on a portion of the carrier comprising an electromagnetic interference (EMI) suppressing material.

9. The antenna assembly of claim 8, wherein the EMI suppressing material comprises ferrite.

10. An antenna positioned at least partially within an antenna housing, the antenna comprising:
a carrier;
a first antenna element positioned on a first surface of the carrier; and
a coupling element positioned on the first surface of the carrier, the coupling element connected to the first antenna element,
wherein the coupling element is capacitively coupled to a metal frame positioned outside the antenna housing, the metal frame electrically isolated from the antenna.

11. The antenna of claim 10, wherein the carrier comprises:
a curved portion;
a first leg portion extending from the curved portion in a first direction; and
a second leg portion extending from the curved portion in a second direction generally perpendicular to the first direction,
wherein a majority portion of the first antenna element is positioned on the curved portion of the carrier.

12. The antenna of claim 11, wherein the coupling element extends along the first leg portion, the curved portion, and the second leg portion of the carrier.

13. The antenna of claim 11, wherein the antenna further comprises:
a second antenna element positioned on the first leg portion of the carrier; and
a third antenna element positioned on the second leg portion of the carrier.

14. The antenna of claim 13, wherein the second antenna element is operable to communicate via an 802.15 communication protocol and the third antenna element is operable to communicate over one or more near field communication (NFC) frequency bands.

15. The antenna of claim 10, wherein the first antenna element is operable over one or more long term evolution (LTE) frequency bands and one or more global positioning system (GPS) frequency bands.

16. The antenna of claim 10, wherein a distance between the coupling element and the metal frame is less than about 2 millimeters (mm).

17. An electronic device, comprising:
a metal frame;
an antenna housing having a sidewall, an exterior surface of the sidewall at least partially enclosed by the metal frame;
an antenna positioned along an interior surface of the antenna housing, the antenna comprising:
a first antenna element operable to communicate over one or more frequency bands; and
a coupling element connected to the first antenna element,
wherein the coupling element is capacitively coupled to the metal frame through the sidewall of the antenna housing.

18. The electronic device of claim 17, wherein the first antenna element is operable over one or more long term evolution (LTE) frequency bands.

19. The electronic device of claim 18, wherein a distance between the coupling element and the metal frame through the sidewall is less than about 2 millimeters (mm).

20. The electronic device of claim 17, wherein the electronic device comprises an electronic locking device.
